(19) United States
(12) Patent Application Publication
(10) Pub. No.: US 2003/0163879 A1
(43) Pub. Date: Sep. 4, 2003

(54) Reactive dye mixtures

(76) Inventors: Colin Brennan, York (GB); Manfred Patsch, Wachenheim (DE)

Correspondence Address: Connolly Bove, Lodge & Hutz, PO Box 2207, Wilmington, DE, 19899-2207, US

(21) Appl. No.: 10/149,686

(22) PCT Filed: Dec. 21, 2000
(86) PCT No.: PCT/EP00/13128

(30) Foreign Application Priority Data
Dec. 22, 1999 (DE) 199 62 228.0

(51) Int. Cl. C09B 62/00

(52) U.S. Cl. 8/543; 8/546

(57) ABSTRACT

Disclosed is a dye mixture including two or more compounds of the formula I

A-D-(B)ₐ—Y—(B)_{b}-D-A (I)

where A, D, B and Y are each as defined in the description part. The mixture provides improved levelness and color strength compared to the corresponding individual compounds.

The present invention relates to reactive dye mixtures that lead to dyeings possessing improved levelness and color strength. GB-A-1283771 and EP-A-0 625 551 disclose reactive dyes of the formula

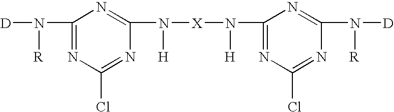

where D is a chromophore (which in the case of GB-A-1283771 is a naphthylazo-phenylene or -naphthalene with at least three sulfonic acid groups and in the case of EP-A-0 625 551 is a broad range of chromophores), R is hydrogen or an optionally substituted alkyl group of 1 to 4 carbon atoms and X is a bridging group, which in the case of GB-A-1283771 is an aromatic group based on phenylene, biphenylene or naphthalene and in the case of EP-A-0 625 551 is an aliphatic bridging group, the NH—X—NH group forming a bridging group between the adjoining triazine cores. The dyes have good lightfastness.

JP-A-62 172 062 discloses dyes in which chromophores are linked by the group

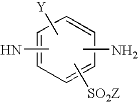

where Y is hydrogen, halogen or alkyl and Z is the reactive group—CH═CH₂ or CH₂CH₂OSO₃H.

British Patent Application 97 158 30.7 describes dyes in which the bridging group contains an aminoalkyl-piperazine. The dyes have the formula

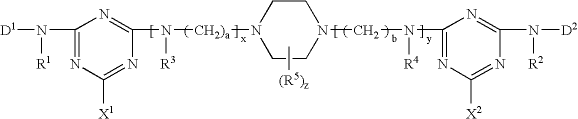

where

R¹, R², R³ and R⁴ are independently H or an optionally substituted alkyl,

X¹ and X² are independently a leaving group or atom,

x and y are independently 0 or 1, provided at least one is 1,

a and b are independently from 2 to 5,

z is 0 or from 1 to 4, and

when x and y are each 1, then a>b,

the or every R⁵ is independently alkyl, and

D¹ and D² are independently a monoazo or polyazo chromophore or a metallized derivative thereof.

GB 98 16 780.2 discloses a dye of the formula D¹-Y-D² where D1 and D² are independently a chromophore of the following formula:

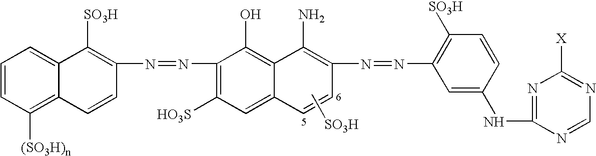

where X is fluorine, chlorine or optionally substituted pyridinium,

n is 0 or 1,

Y is

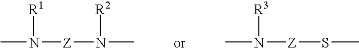

Z is an aliphatic or aromatically cyclic C₅₋₁₂ hydrocarbyl group or consists of at least two of the cyclic carbyl groups joined together, or is an alkylene chain of 1 to 15 carbon atoms or an alkenylene chain of 2 to 15 carbon atoms,

R¹, R² and R³ are independently C₁₋₄-alkyl, hydroxy-C₁₋₄-alkyl or amino-C₁₋₄-alkyl and can form ring structures.

The dyes of the formula indicated in GB 98 16 780.2 are advantageous with regard to lightfastness, buildup and compatibility with other dyes and are useful for dyeing a very wide variety of substrates, especially for dyeing cellulose materials. The use of a mixture of a plurality of different compounds falling within the indicated formula is not disclosed, nor is the presence of different chromophoric groups within one and the same dye molecule.

It is an object of the present invention to provide dyes that in particular provide uniform dyeing coupled with excellent color strength and ease of processing without sensitivity to process variables.

It is a further object of the present invention to provide a process for preparing such dyes and a dyeing process involving such dyes.

We have now surprisingly found that dye mixtures of the formula (I) have advantages over the corresponding individual compounds in that, in particular, dyeings of improved levelness and color strength are obtained.

The invention accordingly provides a dye mixture including two or more compounds of the formula (I) that differ in A and/or Y.

A-D-(B)ₐ—Y—(B)_{b}-D-A (I)

where D is a chromophore of the formula

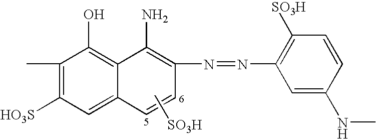

where the second sulfonic acid group of the naphthalene core is present on position 5 or 6, preferably position 6, the A radicals are each a chromophoric group which is attached to D via an azo group, the bridging group Y is a radical of the formulae III, IV, V or VI

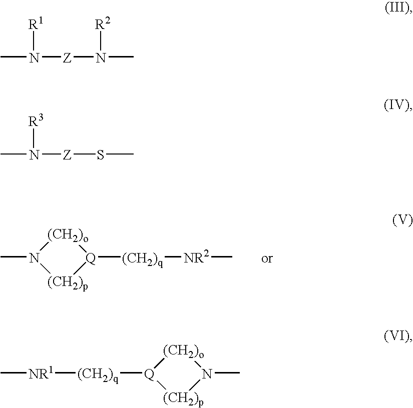

Z is

a C₂-C₁₄-alkylene group, which optionally comprises 1, 2 or 3 NR⁴ or 0 heteroatoms and which is optionally substituted by 1 or 2 OH or COOH groups, R⁴ being H or C₁-C₄-alkyl,

a C₁-C₁₄-alkylene group comprising at least one C₃-C₇-cycloalkylene group (optionally substituted by one or two C₁-C₄-alkyl groups), a phenylene group (optionally substituted by one or two C₁-C₄-alkyl and/or SO₃H groups) and/or a nonaromatic 5- or 6-membered heterocyclic group having one or two nitrogen heteroatoms, or

a C₃-C₇-cycloalkylene group,

where Y can also be a chemical bond when one of the indices a or b is 0 and the other is 1,

o and p are independently 1, 2 or 3,

Q is N or CH,

q is from 0 to 10 subject to the proviso that q cannot be 0 or 1 when Q is N,

R¹, R2 and R³ are independently selected from the group consisting of H, C₁₋₄-alkyl, hydroxy-C₁₋₄-alkyl and amino-C₁₋₄-alkyl,

B is

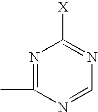

where

X is chlorine or optionally substituted pyridinium,

or including at least one compound of the formula I and at least one compound of the formula Ia

A-D-B—Y—-H (Ia)

where A, D, B and Y are each as defined above,

wherein the compound of the formula I and Ia can also be included in the form of a salt.

In the compounds of the formula (I), A can be a chromophoric group derived from a diazotizable aromatic amino compound which optionally comprises at least one sulfonic acid and/or carboxyl substituent. The amino compound is preferably aniline, orthanilic acid, metanilic acid, sulfanilic acid, 2-aminobenzene-1,4-disulfonic acid, 2-aminobenzene-1,5-disulfonic acid, 2-amino-5-methylbenzene-1-sulfonic acid, 2-amino-5-methoxy-benzene-1-sulfonic acid, 2-aminobenzoic acid, 3-chloro-4-amino-benzene-1-sulfonic acid, a- and b-naphthylamines substituted by at least one sulfonic acid group, carboxylic acid group, halogen, alkyl (especially C₁₋₄-alkyl), acylamino (especially C₂₋₅-acylamino), cyano and aminoalkyl (especially amino-C₁₋₄-alkyl), such as 2-aminonaphthalene-1-sulfonic acid, 2-aminonaphthalene-4,8-disulfonic acid and 2-amino-maphthalene-3,6,8-trisulfonic acid.

Particularly preferred A radicals are:

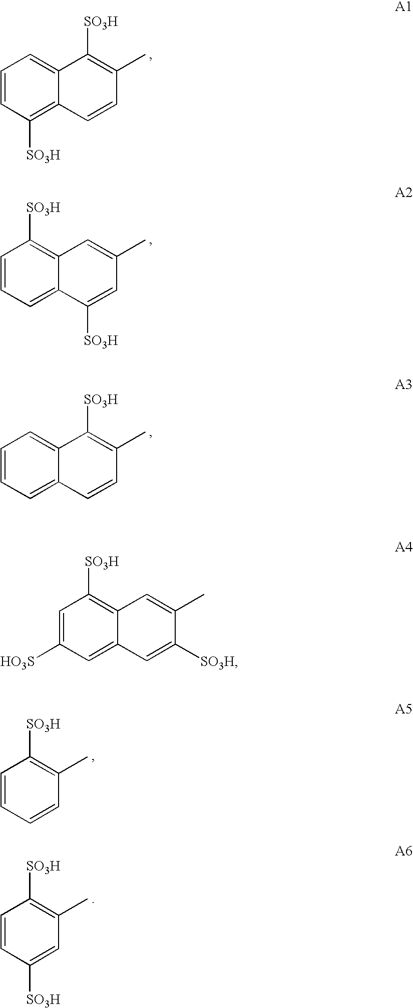

The dye is prepared by diazotizing the amino group of the amine and coupling the diazonium product with the hydroxynaphthylamine of group D.

Substituted pyridinium X is preferably 3-carboxyl, 3-carbamoyl and 4-carboxyl. Preferably X is Cl.

Alkylene Z may be straight-chain or branched. Preference is given to a respectively C₂-C₁₀— or C₁-C₁₀-alkylene group, especially to a respectively C₂-C₈— or C₁-C₈-alkylene group.

R¹, R² and R³ are preferably and independently selected from the group consisting of H, C₁-C₄-alkyl and hydroxyethyl.

Examples of Y where Z is a C₂₋₁₀-alkylene chain, which is optionally substituted by at least one hydroxyl or carboxyl group, are HNC₂H₄NH, HNC₃H₆NH, HNC₄H₈NH, HNC₅H₁₀NH, HNC₆H₁₂NH; HNC₈H₁₆NH; HNC₂H₄N (CH₃), HNC₃H₆N(CH₃), HNC₂H₄N(C₂H₄OH), HNC₂H₄N(C₃H₆OH), HNC₃H₆N(C₂H₅OH), HNC₂H₄N(C₂H₅), HNC₂H₄N(n-C₃H₇, HNC₃H₆N(C₂H₅), HNC₃H₆N(n-C₃H₇), (H₃C) NC₂H₄N(CH₃), (H₃C)NC₃H₆N(CH₃), (H₃C)NC₂H₄N(C₂H₅), HNC₂H₄NH[CH(CH₃)₂], HNC₂H₄N [CH₂CH(CH₃)(OH)], HNCH(CH₃CH₂NH, HNC(CH₃)₂CH₂NH, HNCH₂CH(OH)CH₂NH, HNCH₂C(CH₃)₂CH₂NH, HNCH(C₂H₅)CH₂NH, HNCH₂CH(CH₃)C₃H₆NH, HNCH₂CH(CH₃)N[CH(CH₃)₂], HNC₂H₄S and HNCH(CO₂H)CH₂S.

Particularly preferred examples of Y in which Z is a C₂₋₁₀-alkylene chain are NHC₂H₄NH, NHC₃H₆NH, NHCH(CH₃)CH₂NH, NHC₂H₄N(CH₃), NHC₃H₆N(CH₃), NHCH₂CH(OH)CH₂NH, NHC₂H₄N(C₂H₄OH), NHC(CH₃)₂CH₂NH, NHC₃H₆N(C₂H₄OH), NHC₂H₄S, NHC₂H₄N(C₂H₅), N(CH₃)C₂H₄N(CH₃), NHC₃H₆N(C₂H₇), N(C₂H₄OH)C₂H₄N(C₂H₄OH), HNCH(CO₂H)CH₂S, N[CH(CH₃)₂]CH(CH₃CH₂)NH, HNC₆H₁₂NH′ HNC₃H₆N(CH₃)C₃H₆NH, HNC₂H₄OC₂H₄NH and HNC₂H₄OC₂H₄NH.

When Y contains one or more heteroatoms, these are at least 2 carbon atoms apart from the nitrogen atoms or the sulfur atom of Y and from each other. Examples of Y in which Z is a C₂₋₁₀-alkylene chain that additionally contains a heteroatom are HNC₃H₆N(CH₃)C₃H₆NH, HNC₂H₄OC₂H₄OC₂H₄NH and HNC₂H₄OC₂H₄NH.

The alkylene chain of Z may additionally contain a C₃-C₇-cycloalkyl group or a phenyl radical. Examples of Y in which Z is such a chain are:

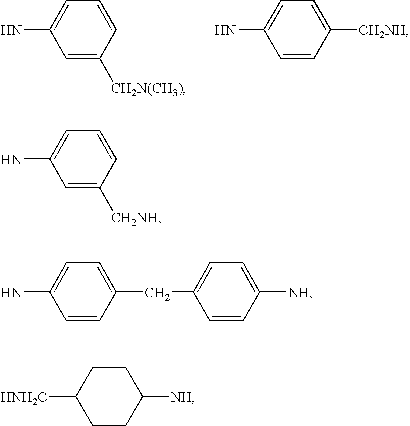

where n is 2 or 3. Of these groups

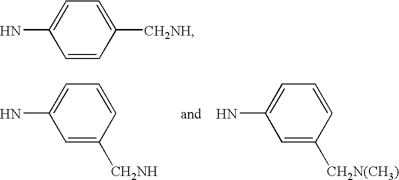

are particularly preferred.

When Z is a C₁-C₁₄-alkylene group comprising a nonaromatic heterocyclic group with one or two nitrogen heteroatoms, it is preferably a 1,4-piperazinyl group, a 1,4-piperidinyl group or a 1,3-pyrrolidinyl group. Examples of Y containing such groups are:

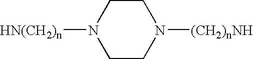

Examples of Y in which Z is a phenylene group are:

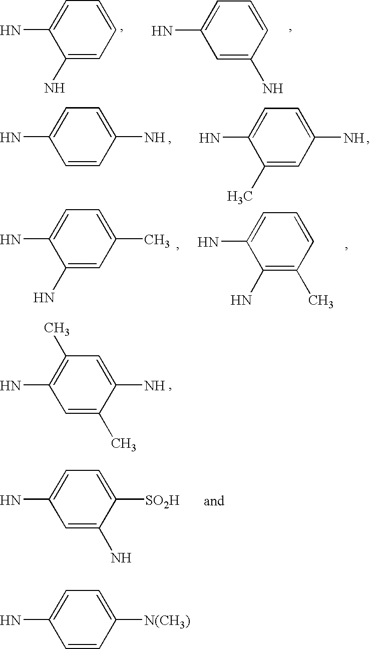

or combinations thereof, for example

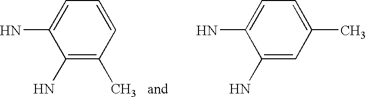

When Y is a radical of the formulae V or VI it is preferably a radical of the formula V or VI where o and p are each 2, Q is N and p is 2, 3 or 4 or where o is 2, p is 1, Q is CH and q is 0, 1, 2 or 3.

C₃-C₇cycloalkylene Z is preferably cyclopentylene or cyclohexylene. Examples of Y in which Z is a C₃-C₇-cycloalkylene group are

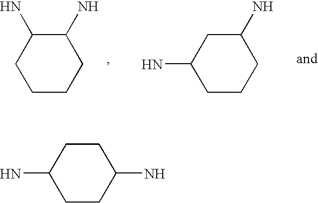

Particularly preferred Z groups are

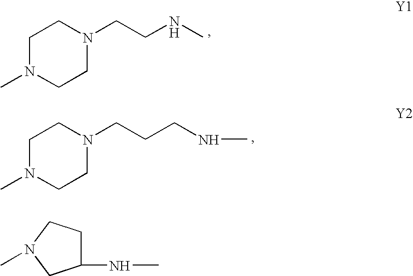

Y is attached to the chromophore D via at least one triazinyl group B. However, Y can also be a chemical bond, so that the D groups can also be linked via a triazinyl group.

The blend ratios of the components in the dye mixtures of the invention are not critical and can vary within very wide limits. They are generally such that the chromophoric group A of a component accounts for from 1 to 99 mol %, preferably from 5 to 95 mol %. Different Y groups are present in a molar ratio of from 99:1 to 1:99 preferably from 95:5 to 5:95. Generally, the mixture includes a main component, which preferably accounts for from 60 to 95 mol %. Generally, the mixture used will have a component accounting for 70-98% by weight, preferably 80 to 95% by weight, based on the total weight of the mixture. The other component or components is or are then included at 2-30% by weight, preferably at 5-20% by weight.

The compounds of the formula I are prepared by diazotizing 4-acetylamino-2-aminobenzenesulfonic acid and coupling with a hydroxynaphthalene of the formula

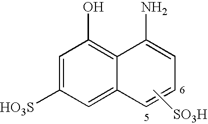

under acidic conditions (pH 2) and subsequently diazotizing an amine of the formula A-NH₂ followed by coupling with the hydroxynaphthylamine under neutral conditions (pH 7). The protective acetyl group on the amino group meta to the azo bond is then removed to obtain a bisazo dye. The bisazo dye can be reacted in a conventional manner with the desired triazine and the resulting compounds are linked by reaction with H—Y—H. The linking can also be effected unilaterally directly on the chromophore, ie. the B group can be missing on one side of the bridging group Y.

The dye mixtures of the invention can be prepared by direct synthesis or by physically mixing the individual dyes. A direct synthesis process according to the invention comprises the following steps:

diazotizing a mixture of at least two different chromophoric amines A-NH₂ and

coupling the resulting diazonium compounds with a compound of the formula II

H-D-(B)ₐ—Y—(B)_{b}-D-H (II)

or with a mixture of at least two compounds of the formula II that differ through different Y groups,

where A, D, B, Y, a and b are each as defined above.

The first variant (coupling with a compound of the formula II) provides a mixture of three compounds differing by virtue of the A radicals. The second variant affords a mixture of at least six compounds differing by virtue of the A and/or Y radicals.

The individual dyes used for preparing a physical mixture are synthesized in a conventional manner, ie. by separately diazotizing at least two different amines A-NH₂ and separately coupling the resulting diazonium compound with the compound of the formula II.

A further inventive process for direct synthesis of the dye mixture comprises the following steps:

diazotizing an amine A-NH₂,

coupling the resulting diazonium compound with a mixture of at least two compounds of the formula II that differ by virtue of the Y group,

where A, D, B, Y, a and b are each as defined above. This affords a mixture of at least two compounds differing by virtue of the Y group.

An alternative to the above direct synthesis comprises the following steps:

diazotizing an amine A-NH₂,

coupling the resulting diazonium compound(s) with at least one compound of the formula

H-D-B—C

where C is a detachable group,

reacting the resulting compound(s) of the formula A-D-B—C with a mixture of at least two compounds H—Y—H, where A, D, B and Y are each as defined above.

The reaction must in each case reflect the mixing ratios desired for the individual moieties. Note that isomer distributions can arise, so that the fraction due to a certain moiety can be subdivided between a plurality of structures.

The reactive dyes of the formula I can also be prepared using a different order than that chosen above. For instance, individual components or mixtures of individual components A, D-B and Y can be reacted.

Whether a direct synthesis from a mixture of all starting components is used, to what extent and in which order intermediates are synthesized or whether the desired dye components are prepared individually as pure substances and subsequently physically mixed depends primarily on which reactive dye mixtures are to be obtained. When a large range of variation is desired, it is generally advantageous to start from mixtures of the constituents A, D-B and Y, where A and Y may each be a plurality of different compounds. When a smaller range of variation is desired, it can be more advantageous to prepare pure compounds and then physically mix them than to carry out a direct synthesis.

Instead of as free acids the dyes of the formula (I) can also be present in the form of their salts, especially in the form of their salts with alkali metals, such as the potassium, sodium, lithium or mixed sodium/lithium salt.

The dyes of the invention can be used for dyeing and printing, especially ink-jet printing, of substrates, for example textile materials and paper. They are generally used in the form of a colorant which includes the dye mixture with or without customary additives, such as wetting agents, dispersants, sequestrants, acids, bases, solvents, etc.

The dyeing process is carried out in a conventional manner and generally at a pH >7, preferably at a pH of from 7.1 to 13, especially at pH 10-12. pH values above 7 can be obtained by conducting the dyeing process in the presence of an acid binding agent. Preferred acid binding agents are alkali metal carbonates, bicarbonates, hydroxides, metasilicates and mixtures thereof, for example sodium bicarbonate, sodium carbonate, sodium metasilicate, sodium hydroxide and the corresponding potassium salts. The dyes are excellent in buildup and are very efficiently fixed on the substrate.

The substrate can be for example textile material, leather, paper, hair or film, and preferably is a natural or synthetic textile material containing amino or hydroxyl groups, for example a textile material such as wool, silk, nylons and modified polyacrylonitrile fibers. It is particularly preferably a cellulose textile material, especially cotton, viscose and regenerated cellulose, for example Tencel. To dye, the dyes are applied to the textile material at a pH above 7, for example by hot dyeing, calender dyeing or printing. The textile materials acquire bright hues and have good lightfastness and washoff stability.

Textile materials containing amine groups, such as wool and nylon textile materials, are dyed using neutral or mildly alkaline dyebaths. The dyeing process can be carried out at constant or substantially constant pH, but dyebath pH can also be changed during the dyeing process, if desired.

The mixed reactive dyes of the invention can be present in liquid or solid form, for example in a granular or powder form.

The dye mixtures of the invention have the following surprising advantages:

a) good color fastness;

b) good development of dyeing, especially at a dyeing temperature of 90° C.;

c) very high dyeing power;

d) high stability to changes in dyeing conditions, especially to changes in the temperature;

e) good washoff;

f) good fixation;

g) good water solubility; and

h) high compatibility with other dyes.

It is particularly surprising that the dye mixtures lead to improved color yield and levelness.

Preferred embodiments of the invention will now be described with reference to examples. Said examples are merely illustrative and are not intended to limit the invention in any way.

### EXAMPLE 1

Process A: Direct Synthesis

An aqueous solution of 2-aminonaphthalene-1,5-disulfonic acid (A1) (0.0785 mol) and 2-aminonaphthalene-4,8-disulfonic acid (A2) (0.0088 mol) in 330 ml of water-ice was diazotized with HCl and sodium nitrite (about 0.09 mol) at pH <1 and 5-10° C. for 1 h. Excess nitrite was decomposed with sulfamic acid, and the resulting solution of the diazo compound was added with stirring to a solution of the compound (1) (0.083 mol) in water at 5-10° C. Coupling was carried out at pH of 6.5-7 using sodium carbonate, and the temperature rose to room temperature overnight. The resulting product (Example 1 in the table) was obtained by drying the entire liquid at 40° C to obtain a product having a Iₘₐₓ of about 615 nm which dyes cotton in a navy green hue having excellent properties with regard to color intensity, lightfastness and levelness that are insensitive to process changes.

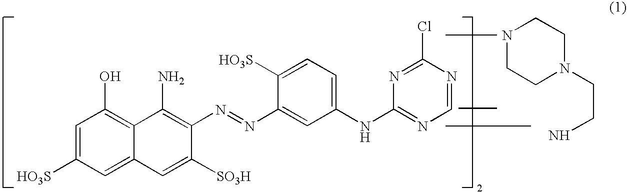

Process B: Physical Mixing

The individual dye components obtained in the preceding synthesis using only 2-aminonaphthalene-1,5-disulfonic acid and 2-aminonaphthalene-4,8-disulfonic acid were dissolved in water in the requisite molar ratio (in this case respectively 90% and 10%). The solution was homogenized by stirring and then dried at 40° C. to obtain a product having a Iₘₐₓ of about 615 nm which dyes cotton in a navy green hue having excellent properties with regard to color intensity, lightfastness and levelness that are insensitive to process changes.

### EXAMPLES 2 to 8 and 13

Processes A and B

The type and/or the relative quantity of the diazo compound which was present in a smaller amount in Example 1 was changed. The examples are reported in Table 1. Main and secondary constituents are interchangeable.

### EXAMPLE 9

Process A: Direct Synthesis

To a solution of 0.05 mol of the compound (2) in 750 ml of water was added at pH 4 a solution which contained a mixture of 0.0228 mol of N-(2-aminoethyl)-piperazine (Y1) and 0.0012 mol of N-(3-aminopropyl)-piperazine (Y2) in 20 ml of water. The pH rose to 8-9 and was maintained at pH 9-9.5 by means of NaOH solution (2.5N); the temperature was 10-15° C. The reaction solution was stirred at room temperature overnight. The resulting product (Example 9 in the table) was obtained by drying the entire liquid at 40° C. to obtain a product having a Iₘₐₓ of about 615 nm which dyes cotton in a navy green hue having excellent properties with regard to color intensity, lightfastness and levelness that are insensitive to process changes.

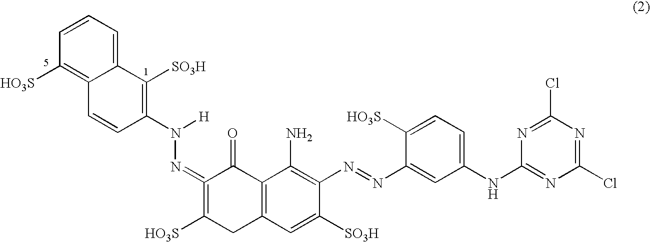

Process B: Physical Mixing

The individual dye components obtained in the preceding synthesis using only N-(2-aminoethyl)-piperazine and N-(3-aminopropyl)-piperazine were dissolved in water in the requisite molar ratio (in this case respectively 95% and 5%). The solution was homogenized by stirring and then dried at 40° C. to obtain a product having a Iₘₐₓ of about 615 nm which dyes cotton in a navy green hue having excellent properties with regard to color intensity, lightfastness and levelness that are insensitive to process changes.

### EXAMPLES 10 and 14

Processes A and B

The type and/or the relative quantity of the bridging amine which was present in a smaller amount in Example 9 was changed. Main and secondary constituents are interchangeable.

### EXAMPLE 11

Process A: Direct Synthesis

Example 1 was repeated except that the indicated diazo constituent was added to a mixture of the compounds (1) and (3) in the appropriate mol % amounts.

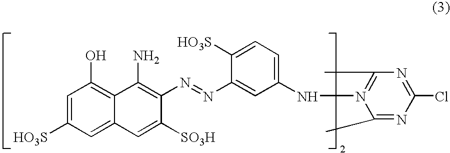

Process B: Physical Mixing

A direct synthesis of the individual components was carried out, ie. the diazo component was coupled separately to the compounds (1) and (3), and the resulting compounds were then physically mixed in appropriate molar ratio.

### EXAMPLE 12

Process A: Direct Synthesis

Example 9 was repeated except that the bridging amine present in the smaller amount (Y2) was omitted and the relative mol % quantity of the bridging amine present in the main amount was increased relative to the dichlorotriazine (2); for example, 0.05 mol of the compound (2) was admixed with 0.026 mol of N-(2-aminoethyl)-piperazine, the relative excess of the bridging amine ensuring incomplete dimerization and the simultaneous formation of the mono-addition product.

Process B: Physical Mixing

The individual components were separately synthesized while adhering to the molar ratio of amine to compound (2). The individual components were physically mixed in the appropriate ratio.

### EXAMPLE 15

Process A: Direct Synthesis

The synthesis was carried out as in Example 11 by coupling reaction of a mixture of compound (3) and of the mixed product obtained by dimerization of compound (4) with the indicated molar ratio of N-(2-aminoethyl)-piperazine (Y1) and N-(3-aminopropyl)-piperazine (Y2), with the diazonium compound of 2-amino-naphthalene-1,5-disulfonic acid (A1).

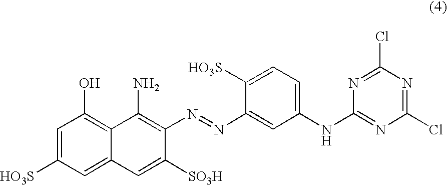

Process B: Physical Mixing

The individual constituents were prepared and physically mixed with each other in the appropriate molar ratio.

### EXAMPLE 16

Process A: Direct Synthesis

The compound (4) was dimerized with a mixture of N-(2-amino-ethyl)-piperazine and N-(3-aminopropyl)-piperazine in a molar ratio 90:10 and then a coupling reaction was carried out with a mixture of the diazonium compounds of 2-aminonaphthalene-1,5-disulfonic acid and 2-aminonaphthalene-4,8-disulfonic acid in a molar ratio of 90:10, as described above. Alternatively, the compound (4) can first be coupled with the mixture of the diazonium compounds, followed by dimerization with the amine mixture.

Process B: Physical Mixing

The individual components were individually synthesized and physically mixed in the appropriate molar ratio.

TABLE 1
List of examples

| | Diazo compound A | Bridging compound Y |
|---|---|---|
| Example | (mol %) | (mol %) |
| 1 | 90% A1 + 10% A2 | 100% Y1 |
| 2 | 90% A1 + 10% A3 | 100% Y1 |
| 3 | 90% A1 + 10% A4 | 100% Y1 |
| 4 | 90% A1 + 10% A5 | 100% Y1 |
| 5 | 90% A1 + 10% A6 | 100% Y1 |
| 6 | 95% A1 + 5% A2 | 100% Y1 |
| 7 | 95% A1 + 5% A4 | 100% Y1 |
| 8 | 95% A1 + 5% A6 | 100% Y1 |
| 9 | 100% A1 | 95% Y1 + 5% Y2 |
| 10 | 100% A1 | 95% Y1 + 5% Y3 |
| 11 | 100% A1 | 90% Y1 + 10% Y = |
| | | chemical bond |
| 12 | 100% A1 | 100% Y1 |
| 13 | 90% A1 + 5% A2 + | 90% Y1 + 5% Y2 + 5% Y3 |
| | 5% A3 | |
| 14 | 100% A1 | 90% Y1 + 5% Y2 + 5% |
| | | Y3 |
| 15 | 100% A1 | 90% Y1 + 5% Y2 + |
| | | 5% Y = chemical |
| | | bond |
| 16 | 90% A1 + 10% A2 | 90% Y1 + 5% Y2 |

| | |
|---|---|
| A1: | 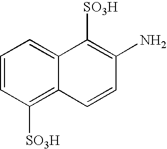 |
| A2: | 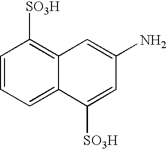 |
| A3: | 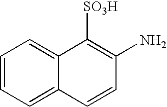 |
| A4: | 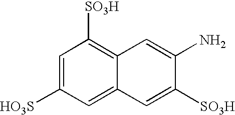 |
| A5: | 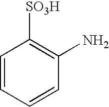 |
| A6: | 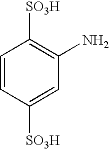 |
| Y1: | 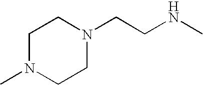 |
| Y2: | 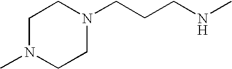 |
| Y3: | 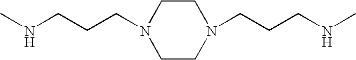 |
| Y4: | 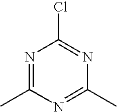 |

We claim:

1. A dye mixture including two or more compounds of the formula (I)
A-D-(B)ₐ—Y—(B)_{b}-D-A (I)
where D is a chromophore of the formula 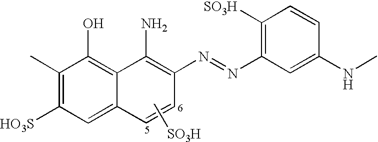
where the second sulfonic acid group of the naphthalene core is present on position 5 or 6, preferably position 6, the A radicals are each a chromophoric group which is attached to D via an azo group, the bridging group Y is a radical of the formulae III, IV, V or VI 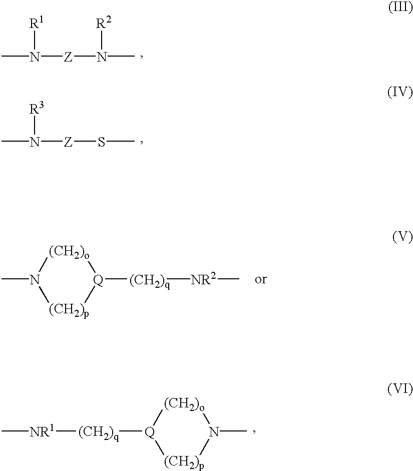
a C₂-C₄-alkylene group, which optionally comprises 1, 2 or 3 NR⁴ or O heteroatoms and which is optionally substituted by 1 or 2 OH or COOH groups, R⁴ being H or C₁-C₄-alkyl,
a C₁-C₄-alkylene group comprising at least one C₃-C₇-cycloalkelene group (optionally substituted by one or two C₁-C₄-alkyl groups), a phenylene group (optionally substituted by one or two C₁-C₄-alkyl and/or SO₃H groups) and/or a nonaromatic 5- or 6-membered heterocyclic group having one or two nitrogen heteroatoms, or
a C₃-C₇-cycloalkylene group,
where Y can also be a chemical bond when one of the indices a or b is 0 and the other is 1,
o and p are independently 1, 2 or 3,
Q is N or CH,
q is from 0 to 10 subject to the proviso that q cannot be 0 or 1 when Q is N,
R¹, R² and R³ are independently selected from the group consisting of H, C₁₋₄-alkyl, hydroxy-C₁₋₄-alkyl and amino-C₁₋₄-alkyl,
B is 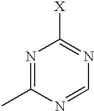
where
X is chlorine or optionally substituted pyridinium,
or including at least one compound of the formula I and at least one compound of the formula Ia
A-D-B—Y—H (Ia)
where A, D, B and Y are each as defined above,
wherein the compound of the formula I and Ia can also be included in the form of a salt.

2. A dye mixture as claimed in claim 1, wherein the compounds comprise different A groups.

3. A dye mixture as claimed in claim 1 or 2, wherein the compounds comprise different Y groups.

4. A dye mixture as claimed in any of claims 1 to 3, wherein the chromophoric A groups are selected from compounds of the group

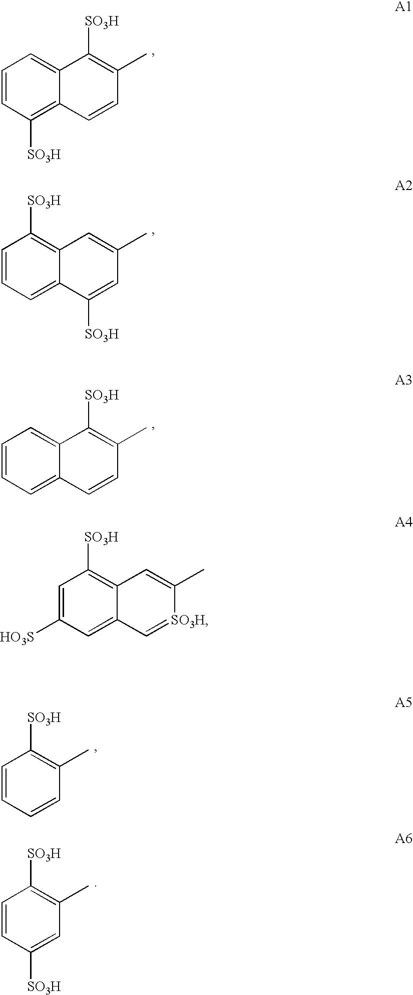

5. A dye mixture as claimed in any of claims 1 to 4, wherein the bridging group Y is selected from compounds of the group

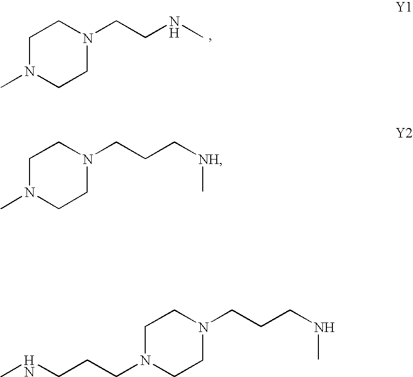

6. A dye mixture as claimed in any of claims 1 to 5, wherein B is

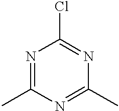

7. A colorant including a dye mixture as claimed in any of claims 1 to 6 and customary additives.

8. A process for dyeing a substrate, which comprises applying a dye mixture as claimed in any of claims 1 to 6 or a colorant as claimed in claim 7 to the substrate at pH above 7.
